(19) United States
(12) Patent Application Publication
(10) Pub. No.: US 2023/0280524 A1
(43) Pub. Date: Sep. 7, 2023

(54) Optical Waveguide Device and Method for Manufacturing the Same

(71) Applicant: Nippon Telegraph and Telephone Corporation, Tokyo (JP)

(72) Inventors: Yoshie Morimoto, Musashino-shi, Tokyo (JP); Kenya Suzuki, Musashino-shi, Tokyo (JP); Osamu Moriwaki, Musashino-shi, Tokyo (JP); Yu Kurata, Musashino-shi, Tokyo (JP)

(21) Appl. No.: 18/005,711

(22) PCT Filed: Aug. 25, 2020
(86) PCT No.: PCT/JP2020/031934

§ 371 Date: Jan. 17, 2023

(51) Int. Cl. G02B 6/02; G02B 6/12

(52) U.S. Cl. CPC G02B 6/02004; G02B 6/12016; G02B 2006/12088; G02B 2006/12035

(57) ABSTRACT

An optical waveguide component is configured to have a dual structure in which a core region of the first optical waveguide is contained within the core region of the second optical waveguide in a cross-section perpendicular to the length direction of the optical waveguide. The refractive index of a first material of the core of the first optical waveguide is greater than a refractive index of a second material of the core of a second optical waveguide. The refractive index of a second material constituting the core of a second optical waveguide is greater than a refractive index of a third material constituting cladding of the second optical waveguide. The center height of the core of the first optical waveguide and the center height of the core of the second optical waveguide are aligned, which solves connectivity problems caused by worsened butt coupling efficiency, and incomplete adiabatic coupling in an SSC structure of prior art.

### TECHNICAL FIELD

The present invention relates to an optical waveguide component that utilizes an optical communication.

### BACKGROUND ART

With the increase in communication traffic in data centers in recent years, the importance of optical wiring technology for elements in computer housings is increasing. Among them, a silicon photonics technology, which can integrate a large number of optical circuits at high density, is attracting attention.

A silicon optical circuit, which is an optical transmission medium in the silicon photonics technology, is composed of a silicon thin wire waveguide having Si as a core and SiO2 as a clad. In the silicon thin wire waveguide, difference in a specific refractive index between the core and the clad is about 40%, and light propagation is possible within a very small cross-sectional region of several hundred nm square in the vicinity of 1550 nm, which is the wavelength band used for a single mode communication. Since an allowable bending radius is as small as several μm, it is possible to form a complicated wiring pattern in a narrow area, and large-scale integration of optical circuits by silicon photonics technology is expected.

Since the silicon optical circuit is usually formed on an SOI (Silicon On Insulator) substrate, the silicon optical circuit and an electronic circuit can be monolithically integrated. From the viewpoint of manufacturing technology, mature semiconductor microfabrication technology can be applied, so that a fine pattern can be easily formed. By combining silicon photonics technology with semiconductor technology and electronic circuit technology, it is expected that optoelectronic integrated devices will be realized.

On the other hand, the silicon optical circuit has a problem in terms of connection with other optical elements. When connecting optical elements to each other, it is important to match mode fields of light propagating in the optical elements in order to reduce the loss at a connection point. When two optical elements are butted and connected, a coupling efficiency of the propagating light is determined by the overlap integral of both the mode fields. Mode field diameter (MFD) of the silicon optical circuit is about 300 nm. Here, consider a connection with a single mode fiber (SMF) used as the optical transmission medium outside the circuit inside the computer housing. The MFD of a general SMF used for long-distance transmission is about 9 μm, and the MFD of even the SMF designed for the high specific refractive index difference for connection with a small optical waveguide of the MFD is about 4 μm. As described above, the MFD of the silicon optical circuit is 10 to several tens of times smaller than the MFD of the SMF, and when the silicon optical circuit and the SMF are directly connected, a large coupling loss occurs due to the inconsistency of the MFD.

Further, when connecting the silicon optical circuit including a plurality of channels and a plurality of SMFs, there is also a problem of a difference in pitch between cores between the silicon optical circuit and the SMF. As described above, a silicon optical waveguide is capable of light propagation within very small cross-sectional region of several hundred nm square. Therefore, even when arranging a plurality of channels on a silicon optical circuit, the pitch between the cores can be reduced to about several μm, and high-density wiring can be performed. On the other hand, in SMF including a plurality of optical fibers, the pitch between cores of 125 μm and 250μμ has already been standardized, and the corresponding products are widely distributed in the market. Therefore, in order to connect to multiple SMFs with a standardized pitch at the ends while maintaining a high wiring density in the silicon optical circuit, the core-to-core pitch must be aligned between the silicon optical circuit and the SMF. That is, it is necessary to configure a pitch conversion wiring pattern that expands the inter-core pitch of the silicon thin wire waveguide so as to match the inter-core pitch of the SMF in the vicinity of the connection portion of the silicon optical circuit with the SMF.

In this pitch conversion wiring pattern, it is necessary to expand the core-to-core pitch of several μm, which was originally arranged at high density, to 100 μm or more for SMF connection, and the silicon optical circuit becomes large and wiring length becomes long. Silicon photonics are excellent for high-density integration of optical circuits, but propagation loss of silicon thin waveguides reaches 3 dB/cm. Propagation loss, which was not a problem in extremely small region in the silicon optical circuit, has become a serious problem as the entire optical circuit becomes larger and the wiring length becomes longer. In order to solve the problem of connectivity between the silicon optical circuit and the SMF, a method of inserting a spot size conversion structure (SSC) and a pitch conversion structure has been proposed.

FIG. 5 is a diagram showing the configuration of the spot size conversion (SSC) structure of the prior art. FIG. 5 is shown a top view and a cross-sectional view cut by a-a line of a silicon optical circuit 500 which includes two optical waveguide cores 501 and 502 having difference of MFDs, and an SSC structure portion 530 for mitigating the effects of MFD differences. Referring to the cross-sectional view looking at the x-z plane, the underclad layer 504 is configured on a Si substrate 503, and the core 501 of the silicon thin wire waveguide with the small MFD is further formed on the underclad layer 504. The silicon optical circuit 500 is further entirely covered with an overclad layer 505. In FIG. 5, the Si substrate 503, an underclad 504, and the Si core 501 are manufactured by using the SOI substrate as a common substrate. The configuration of the silicon optical circuit including this SSC structure will be described later together with the problems.

In an SSC structure portion 530, the tip of a core 501-2 is a tapered reverse taper portion 501-1, and a planar optical waveguide core 502 is arranged so as to cover the reverse taper portion 501-1. The difference in the specific refractive index between the planar optical waveguide core 502 and the underclad layer 504 and the overclad layer 505 is smaller than the difference in the specific refractive index between the core 501-2 of the silicon thin wire waveguide and the underclad layer 504 and the overclad layer 505. Further, the planar optical waveguide core 502 has a larger core cross-sectional area and MFD than the core 501 of the silicon thin wire waveguide. The light within the core 501-2 of the silicon thin wire waveguide cannot be completely confined within the core of the reverse taper shape as it approaches to the core tip at the reverse taper portion 501-1 of the SSC structure portion 530, and leaks to the cladding around the reverse taper portion 501-1. The light leaked from the reverse taper portion 501-1 adiabatically transitions to the planar optical waveguide core 502 covering a silicon thin wire waveguide core 501-2. Since this light transition process is adiabatic, theoretically no loss of light energy occurs.

As the planar optical waveguide 502 having the larger MFD than the Si core in FIG. 5, a quartz-based optical waveguide having SiOₓ as a core and SiO₂ as a clad material, a polymer optical waveguide having a polymer material as the core and the clad material, and the like are used. In any combination of these plane optical waveguide materials, the difference in specific refractive index is about 1% to several %. By the SSC structure portion 530, since the cross-section is extended from a few hundred nm squares of the Si core 501-2 to several μm squares of the planar optical waveguide core 502, the coupling efficiency with the SMF can be improved. In particular, if the quartz-based optical waveguide, which is the quartz-based material similar to optical fiber, is used as the planar optical waveguide 502, it has low loss in a communication wavelength band, low temperature dependence, and low polarization dependence, further, high reliability and a high-performance optical device can be obtained.

Planar optical waveguides such as quartz-based optical waveguides have the larger core size than the Si core. Propagation loss in the planar optical waveguide ranges from 0.1 dB/cm or less to 0 dB/cm. It stays at about several dB/cm and can be realized without the large propagation loss even if the wiring length exceeds several tens of cm. Further, it is possible to cope with wide range of inter-core pitches of about several tens of μm to several hundreds of μm, and it is possible to form the pitch conversion structure with increase in size of the entire optical circuit and increase in wiring length without the large propagation loss.

As described above, by combining the planar optical waveguide typified by the quartz-based optical waveguide with the silicon optical circuit, two types of optical waveguides with different MFDs can be connected with low loss, and the connectivity of silicon photonics technology is improved (NPL 1).

### CITATION LIST

### Non Patent Literature

[NPL 1] B. Ben Bakir, et al., “Low-loss (<1 dB) and polarization-insensitive edge fiber couplers fabricated on 200-mm silicon-on-insulator wafers”, 1 Jun. 2010, IEEE Photon. Technol. Lett., Vol. 22, No. 11, pp. 739-741

### SUMMARY OF INVENTION

### Technical Problem

However, in the conventional optical circuit combining optical waveguides having different MFDs, a problem of complexity and cost in the manufacturing process still remains. There are roughly two approaches to the method of manufacturing the optical circuit that combines the silicon optical circuit having optical waveguides with different MFDs and the planar optical waveguide. One is a hybrid integration that combines different substrates, and the other is a monolithic integration that uses a single common substrate.

Hybrid integration is a method in which the silicon optical circuit having different MFD optical waveguides and the planar optical waveguide are respectively manufactured on the separate substrate, and then integrated. In the case of hybrid integration, a process (also called an alignment process) of accurately aligning the silicon thin-wire waveguide core and the planar optical waveguide core is required. For the optical waveguide with a very thin core of several hundred nm, such as the silicon thin wire waveguide core of the silicon optical circuit, there is a high demand for alignment accuracy, and a problem with the high-precision alignment process is that is costly.

Monolithic integration is a manufacturing method for integrating different materials of the silicon optical circuit and the planar optical waveguide on the same substrate, and can solve the above-mentioned problem of hybrid integration. In monolithic integration, by simultaneously integrating the silicon optical circuit and the planar optical waveguide on the common SOI substrate, the complicated alignment process is not required, and deterioration of coupling efficiency due to misalignment can be minimized. However, even when manufactured by monolithic integration, there is a problem with the connectivity between the silicon thin wire waveguide and the planar optical waveguide. Here, with reference to FIG. 5 again, the problem of connectivity in the case of monolithic integration will be described. As described above, in the silicon optical circuit 500 of FIG. 5, the spot size is converted by the SSC structure portion 530, and the coupling loss due to the mismatch of the MFD is suppressed.

The thickness of the silicon thin wire waveguide core 501 of the optical circuit 500 shown in FIG. 5 is several hundred nm, and the thickness of the planar optical waveguide core 502 is about several μm. In the cross-sectional view of FIG. 5, the difference in the relative dimensions of the thicknesses of the two cores is compressed to illustrate each portion easier to see, but it is clear that the center height of the core 501 and the center height of the core 502 do not match about the structure. When an adiabatic coupling from the silicon thin wire waveguide core 501 to the planar optical waveguide core 502 is used, complete coupling is theoretically possible even if the center heights of the cores do not match. However, in reality, the adiabatic coupling efficiency depends on the dimensional accuracy of the silicon thin waveguide core and the optical characteristics of the planar optical waveguide core. For this reason, not all light energies make adiabatic coupling to all optical circuits manufactured in the same process.

If the adiabatic coupling is incomplete, the light energy remaining without the adiabatic coupling will be butt-coupled to the planar optical waveguide 520 at the end of the silicon optical circuit 510, i.e., the SSC structure portion 530. Generally, in butt coupling, the coupling efficiency is determined by the overlap integral of the mode field of the optical element to be connected, therefore, when the center heights of the two connected cores are different as shown in FIG. 5, the coupling efficiency may be reduced.

In order to improve the above-mentioned butt coupling efficiency, a method of matching the center heights of the silicon optical circuit core and the planar optical waveguide core manufactured on the SOI substrate is also being studied. In this case, an etching process for scraping off a BOX layer of the SOI substrate is required. In the case of the configuration of FIG. 5, a portion of the underclad layer 504 is removed in the planar optical waveguide 520, which causes a problem that the manufacturing process becomes complicated. As described above, in the optical circuit in which optical waveguides of different materials are monolithically integrated on one common substrate, the optical waveguide component capable of connecting two types of optical waveguides having significantly different MFDs with low loss and a simple manufacturing method thereof are desired.

The present invention has been made in view of such the problem, and provides a novel optical waveguide structure capable of providing different optical waveguides made of different materials at low loss and low cost, and a method for manufacturing the same.

### Solution to Problem

One embodiment of the present invention is an optical waveguide component, in which an optical waveguide having a different mode field diameter (MFD) is formed on a substrate, an optical waveguide component comprising: a first optical waveguide including a first core made of a first material, and a clad made of a second material formed above and below the first core; a second core made of the second material formed by extending from the clad along the first core; a lower clad made of a third material configured between the substrate and the second core, and a second optical waveguide including an upper clad configured on the second core, wherein the region of the first core is contained in the region of the second core in a cross-section perpendicular to the lengthwise direction of the optical waveguide, and the first material has the highest refractive index, and the third material has the smallest refractive index.

One embodiment of the present invention is a method for manufacturing an optical waveguide component including a first optical waveguide and a second optical waveguide having a different mode field diameter (MFD), a method for manufacturing an optical waveguide component comprising: a step of forming a first layer to be a lower clad on a substrate; a step of forming a second layer for the lower core of the second optical waveguide by a material having a higher refractive index than the first layer; a step of forming a third layer for a core of the first optical waveguide by a material having an even higher refractive index than the second layer; a step of forming a core of the first optical waveguide by processing the third layer;
a step of forming a fourth layer for the upper core of the second optical waveguide by a material having a refractive index similar to a refractive index of the second layer; a step of forming a core of the second optical waveguide by processing collectively the second layer and the fourth layer; and a step of forming a fifth layer for an upper clad by a material having a lower refractive index than the second layer and the fourth layer.

### Advantageous Effects of Invention

According to the present invention, the structure of the optical waveguide connecting different optical waveguides of different materials with low loss and the method for manufacturing the same can be obtained.

### BRIEF DESCRIPTION OF DRAWINGS

FIG. 1 is showing the structure of an optical waveguide component of the 1st Embodiment of this disclosure.

FIG. 2 is showing the structure of the optical waveguide component including a double structure and another waveguide structure.

FIG. 3 is showing the structure of the optical waveguide component of the second embodiment of this disclosure.

FIG. 4 is a diagram explaining each process of the manufacturing method of the optical waveguide component of this disclosure.

FIG. 5 is showing a structure of the spot size conversion structure of the prior art.

### DESCRIPTION OF EMBODIMENTS

An optical waveguide component of the present disclosure provides a configuration in which optical waveguides of different materials can be monolithically integrated on a common single substrate, and two types of optical waveguides having different mode field sizes are connected with low loss. The optical waveguide component of the present disclosure is configured to have a double structure in which core region of a first optical waveguide is contained in the core region of a second optical waveguide in a cross-section perpendicular to the length direction of the optical waveguide. A refractive index of the first material of a core of a first optical waveguide is larger than a refractive index of a second material of the core of the second optical waveguide. Further, the refractive index of a second material constituting the core of the second optical waveguide is larger than the refractive index of a third material constituting a clad of the second optical waveguide. By aligning the center height of the core of the first optical waveguide with the center height of the core of the second optical waveguide in the direction perpendicular to the substrate surface, the imperfections of an adiabatic coupling in an SSC structure portion of the prior art, and the problem of connectivity due to deterioration of butt coupling efficiency can be eliminate.

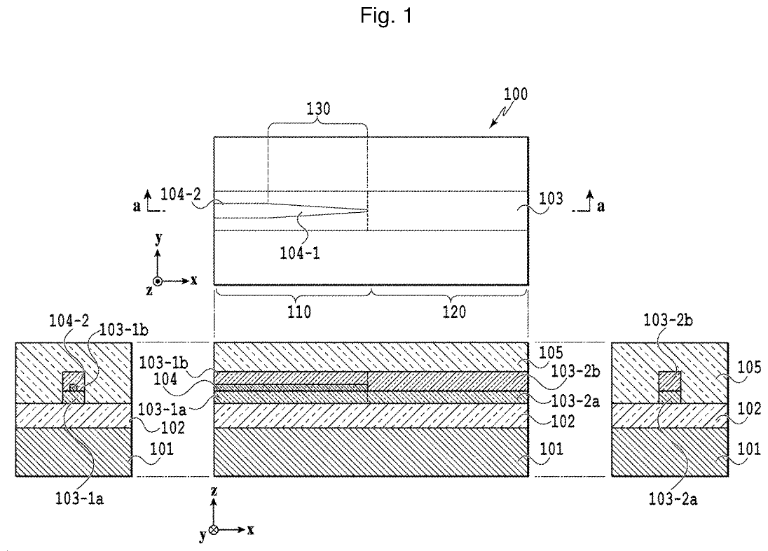

FIG. 1 is a diagram showing a configuration of the optical waveguide component including the dual structure of the present disclosure. FIG. 1 is a top view of the two optical waveguides 110 and 120 toward the plane of a substrate 101 (x-y plane), a side view (x-z plane) passing through the center of each core 104 and 103 of the two optical waveguides, and the two end views (y-z plane) of cross-section cut perpendicular to the length direction of the optical waveguide. An optical waveguide component 100 of FIG. 1 has the first optical waveguide having a first core size and a corresponding MFD, and the second optical waveguide having a second core size and a corresponding MFD formed, on the common substrate 101 has a structure connected optically. The second core size of the second optical waveguide is larger than the first core size of the first optical waveguide. FIG. 1 shows two optical waveguides 110 and 120 obtained by cutting out only a portion of an optical circuit monolithically integrated on the substrate 101, the number of optical waveguides is not limited to this, and other optical waveguides may be included in the waveguide component 100. In the top view (x-y plane) of FIG. 1, the clad 105 at the uppermost portion is removed.

More specific configurations of the two optical waveguides are as follows. In a first optical waveguide 110, the core 104 is formed of the first material, a clad 103-1 is formed of the second material, and in the second optical waveguide 120, a core 103-2 is the second material, clads 105 and 102 is made of the third material. In the optical waveguide component 100 of the present disclosure, as long as the relationship of the refractive indexes n₁ n₂ and n₃ of the first material, the second material, and the third material, is satisfied that the refractive index n₁ of the first material is the highest, and the refractive index n₃ of the material is the lowest, the type of the material of each optical waveguide does not matter. In short, it suffices that the following equation holds for the refractive indexes n₁, n₂, and n₃ of the three materials.

formula (Math. 1)

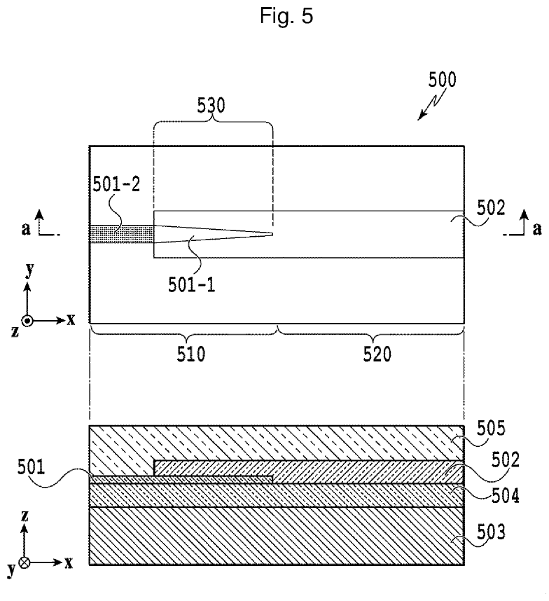

When looking at the cross-section (end view) cut perpendicular to the length direction of the optical waveguide, two optical waveguides 110 and 120 optically connected can be seen that the core 104 of the first optical waveguide 110 is contained a core 103 of the second optical waveguide. In the top view and the side view of FIG. 1, the boundaries are shown by using dotted lines in order to distinguish the regions of the two optical waveguides, but as is clear from the fabrication process described later, there is no physical boundary between the two optical waveguides. For the second material, the clad 103-1 (103-1a, 103-1b) of the first optical waveguide and the core 103-2 (103-2a, 103-2b) of the second optical waveguide can be regarded as one piece through two optical waveguides 110 and 120. Looking at the cross-section perpendicular to the length direction of the optical waveguide, the relationship is such that the core region of the first optical waveguide is contained inside the core region of the second optical waveguide, as if it were a pencil and its core. Further, in the optical waveguide component 100 of FIG. 1, when viewed in a cross-section perpendicular to the length direction of the optical waveguide, the core region of the first optical waveguide is included in the core region of the second optical waveguide, and the two cores are configured so that the center heights of the are the same. Such the “double structure” or “nested structure” of the optical waveguide can solve the problem of loss due to the deviation of the center height position of the core in the conventional monolithic integration shown in FIG. 5.

In the following description of the embodiment, as a specific example, the case, where the first material is Si, the second material is SiO₂ having a relatively high refractive index, and the third material is SiO₂ having a relatively low refractive index, will be described. In the case of this material example, the magnitude of the refractive index can be expressed by the relationship of Si>high refractive index SiO₂>low refractive index SiO₂. The materials that can be used for each portion of the two types of optical waveguides are not limited to these, and for example, Si, SiN, SiON, and the like can be used as the first material. Further, SiO₂, SiOx, a polymer and the like can be used as the second material and the third material. Hereinafter, the structure of the optical waveguide component of FIG. 1 will be described by taking the above-mentioned specific material as an example.

Returning to FIG. 1 again, the optical waveguide component 100 is configured on the substrate 101. The substrate 101 is a substrate having a smooth surface on which a SiO₂ layer can be formed immediately above the substrate 101. The SiO₂ layer 102, which is the third material having the lowest refractive index, is provided on the substrate 101. Referring to the top view of FIG. 1, the first optical waveguide 110 and the second optical waveguide 120 are configured on the substrate 101. The first optical waveguide 110 includes a Si core 104 having the highest refractive index, and as shown in the top view, a Si core 104-2 and the tapered waveguide 104-1 whose width narrows toward the second optical waveguide 120. Referring to the cross-sectional view, the Si core 104 is formed on a lower SiO₂ core portion 103-1a, and an upper SiO₂ core portion 103-1b is formed so as to cover the Si core 104.

The second optical waveguide 120 comprises the SiO₂ core 103 on the SiO₂ layer 102, and the SiO₂ core 103 includes two portions of an upper SiO₂ core portion 103-2b and a lower SiO₂ core portion 103-2a as referring to a side view. In the following description, for the sake of simplicity, the term SiO₂ core 103 shall be referred to the entire SiO₂ region of the four core portions 103-1a, 103-1b, 103-2a, and 103-2b, which span the two optical waveguides. The SiO₂ core 103 will be composed of the second material having an intermediate refractive index. As will be described later, since the upper and lower core portions 103-2a and 103-2b are manufactured by different steps, it may be difficult to obtain a strictly identical refractive index.

However, in the second optical waveguide 120, the SiO₂ core 103 is configured to have substantially the same refractive index so that the upper and lower core portions 103-2a and 103-2b literally function as the “core” of the optical waveguide. On the other hand, it should be noted that in the first optical waveguide 110, the upper and lower core portions 103-1aand 103-1b actually function as “clad” of the optical waveguide.

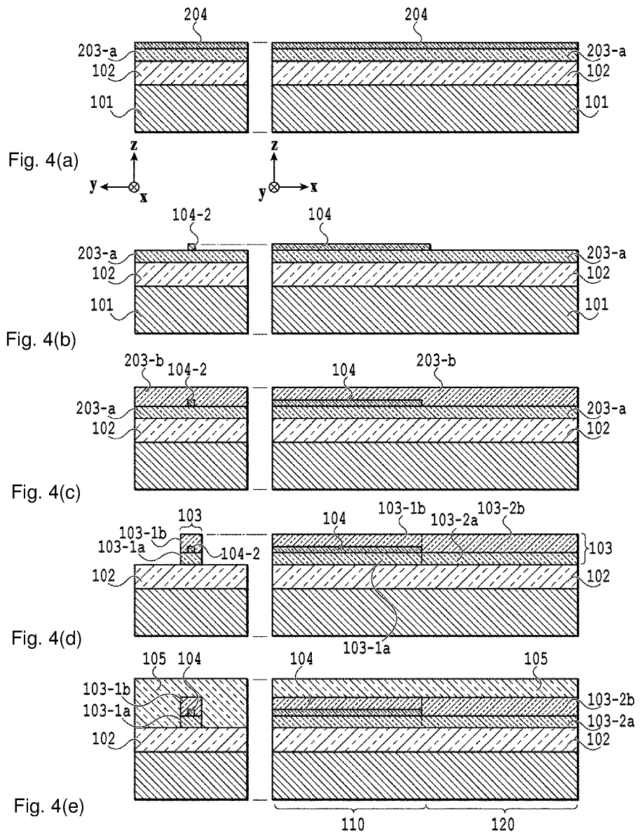

In the optical waveguide component 100 of the present disclosure, it should be noted that the materials in the upper layer clad 103-1b and the lower layer clad 103-1a of the first optical waveguide 110, which is a high refractive index difference waveguide is same as the material of the core 103 of the second optical waveguide 120, which is a low refractive index difference waveguide. As described in the manufacturing method described later together with FIG. 4, among the SiO₂ core 103 composed of four core portions, the SiO₂ regions (103-a) of the lower core portions 103-1a and 103-2a are created in one process. Further, among the SiO₂ core 103 composed of four core portions, the SiO₂ region (103-b) of the upper core portions 103-1b and 103-2b is also created in one process. The optical waveguide component 100 of the present disclosure can realize a configuration in which two types of optical waveguides having cores having different refractive indexes are connected with low loss by a simple process equivalent to the production of the optical waveguide component by a general lamination process. The etching process for scraping off a BOX layer of an SOI substrate, as described in an SSC structure portion of the prior art in FIG. 5, is unnecessary.

The entire two optical waveguides 110, 120 are covered with an upper cladding of the SiO₂ layer 105 made of a third material having the lowest refractive index. Therefore, it should also be noted that the Si core 104 of the first optical waveguide 110 is surrounded by a clad of a double structure.

Arranging the optical waveguide components in FIG. 1 in descending order of refractive index, the relationship is Si core 104→SiO₂ core 103→SiO₂ clads 102 and 105. That is, the refractive index of the SiO₂ core portions 103-2a and 103-2b has a relationship is larger than the refractive index of the cladding of the SiO₂ layer 102 and the SiO₂ layer 105. It should be noted here that the refractive indexes of the SiO₂ layer 102 and the SiO₂ layer 105 do not have to be the same. That is, as long as the refractive index of the SiO₂ layers 102 and 105 is smaller than that of the SiO₂ core 103-2 of the second optical waveguide, the second optical waveguide 120 can confine light within the core and function as the optical waveguide. Hereinafter, the “double structure” of each portion of the optical waveguide component and the core of FIG. 1 will be described in more detail.

### Configuration of First Embodiment

There are two types of optical waveguides in the optical waveguide component 100 of FIG. 1. That is, one is a first optical waveguide 110 having a SiO₂ core portion 103-1a as an underclad, a Si core 104 as a core, and a SiO₂ core portion 103-1b, as an overclad.

The other is a second optical waveguide 120 in which the SiO₂ layer 102 is underclad, the SiO₂ core 103 is the core, and the SiO₂ layer 105 is overclad.

In the first optical waveguide 110, the Si core 104 is sandwiched between the SiO₂ core portion 103-1a and the SiO₂ core portion 103-1b that function as a “clad”, and the width of the Si core 104 is narrower structure than the width of the SiO₂ core portion 103-1. Therefore, the optical waveguide component 100 is a planar optical circuit, but a “dual structure” of cores is formed that the cross-sectional region of the Si core 104 of the first optical waveguide fits completely within the cross-sectional region of the SiO₂ core 103 of the second optical waveguide. Further, as is clear from the left end view of FIG. 1, it can be said that it forms “double structure” of clads, where the Si core 104 in the first optical waveguide 110 has an inner clad by the SiO₂ core portion 103-1 and an outer clad by the SiO₂ layers 103 and 105.

Therefore, the present invention is can be implemented as an optical waveguide component, in which an optical waveguide having a different mode field diameter (MFD) is formed on a substrate 101, an optical waveguide component comprising: a first optical waveguide 110 including a first core 104 made of a first material, and a clads 103-1a and 103-1b made of a second material formed above and below the first core; a second core 103 made of the second material formed by extending from the clad along the first core; a lower clad 102 made of a third material configured between the substrate and the second core, and a second optical waveguide 120 including an upper clad 105 configured on the second core, wherein the region of the first core 104 is contained in the region 103 of the second core in a cross-section perpendicular to the lengthwise direction of the optical waveguide, and the first material has the highest refractive index, and the third material has the smallest refractive index.

The optical waveguide component 100 needs to have the above-mentioned double structure of the core in an SSC region 130 that gradually expands the MFD of the light propagating in the core.

That is, it is desirable that the SSC region 130, which gradually expands the MFD of the light propagating in the core, is formed in the double structure portion of the core in the first optical waveguide. The structure for the SSC function is not limited to a specific one, but the Si core 104 can be realized by a structure that passes from a core 104-2 having a constant width to a tapering tapered shape portion 104-1 as shown in the SSC region 130 in FIG. 1. Further, the Si core 104 may also have a tapered shape in the substrate vertical direction (z-axis direction) where the height of the Si core 104 gradually decreases. The Si core 104 can also be realized by a segmented structure divided in the light propagation direction (x-axis direction).

That is, by segmenting the Si core 104 so that the region (segment) in which the core is formed and the region in which the core is not formed are alternately repeated, the light confinement is gradually weakened and the adiabatic transition is generated. Further, both the tapered shape and the segment shape may be combined to form the SSC region.

On the other hand, in the region away from the boundary of the connection portion where the first optical waveguide 110 does not have the SSC function, it is not always necessary to have the above-mentioned double structure of the core. In the optical waveguide component 100, in a region not shown in FIG. 1, away from the vicinity of the connection portion of the first optical waveguide 110 and the second optical waveguide 120, the first optical waveguide 110 and the second optical waveguide 120 of FIG. 1 may make a transition from each structure to another structure.

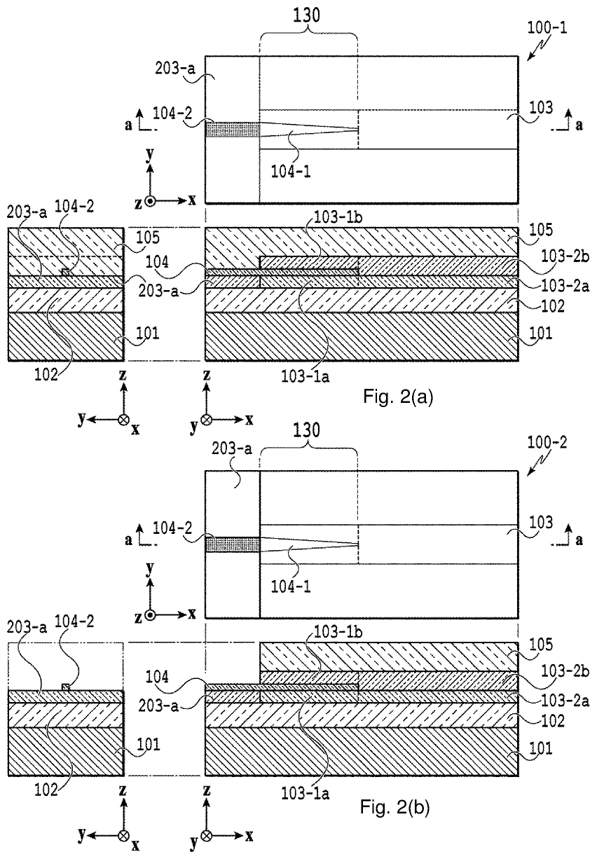

FIG. 2 is a diagram showing the configuration of the optical waveguide component including the dual structure and another waveguide structure. (A) and (b) of FIG. 2 are diagram showing the configuration of a modification of the optical waveguide component of FIG. 1, a top view looking at substrate plane (x-y plane), a side view of the cross-section (x-z plane) perpendicular to the substrate plane containing the optical waveguide, and an end view of the optical waveguide viewed in a cross-section perpendicular to the length direction (y-z plane), respectively. Further, each top view shows the clad 105 at the uppermost portion removed.

The optical waveguide component 100-1 of (a) of FIG. 2 comprises the core portion 103-1b, which functions as the overclad of the first optical waveguide 110, is limited to only on the tapered shape portion 104-1 in the SSC region 130. That is, the rectangular Si core 104-2 of the first optical waveguide 110 is directly covered with the SiO₂ layer 105 that functions as the overclad. In the case of the structure (a) of FIG. 2, in the Si core 104 outside the SSC region 130, light is confined by the underclad of the SiO₂ core portion 103-1a of the second material and the overclad of the SiO₂ layer 105 of the third material. The function as the optical waveguide is no different from that of the first optical waveguide 110 in FIG. 1. At the end of the Si core 104 of the optical waveguide component 100-1 of (a) of FIG. 2, since an optical circuit of a silicon thin wire waveguide will be configured, the patterning for the core 103 of the second material will be eliminated, and the optical circuit of the silicon thin wire waveguide is configured at the end of the Si core 104. In the optical circuit section, it is not necessary to form or perform patterning for the material layer of a planar optical waveguide core on a silicon thin wire waveguide core, so that the factors that deteriorate the silicon circuit are reduced.

The optical waveguide component 100-2 of (b) of FIG. 2 comprises the core portion 103-1b, which functions as the overclad of the first optical waveguide 110, is limited to only on the tapered shape portion 104-1 in the SSC region 130.

In the configuration of (b) of FIG. 2, there is no overclad on the rectangular Si core 104-2 of the first optical waveguide 110, and the Si core 104 is exposed. Even in this structure, in the Si core 104 outside the SSC region 130, light is confined by the underclad by the SiO₂ core portion 103-1a of the second material, and the air having a large refractive index difference from the Si core. In the silicon thin wire waveguide at the tip of the Si core 104 of the optical waveguide component 100-2 of (b) of FIG. 2, there is an advantage that light can be trapped more strongly, the core can be made thinner, and the bending radius can be made smaller.

As described above, the form of the optical waveguide can be changed at the tip of the first optical waveguide 110 in FIG. 1, as shown in (a) and(b) of FIG. 2, and the form of the optical waveguide can be also changed at the tip of the second optical waveguide 120. Note that the double structure of the cores of two optical waveguides having different core sizes in the optical waveguide component of the present disclosure is necessary in the SSC region 130, and the optical waveguide component 100 of FIG. 1 is a part of the integrated optical circuit.

Thickness of Each Layer, Center Height Aligning Structure

Returning again to the optical waveguide component 100 of FIG. 1, the thickness of the underclad SiO₂ layer 102 and the overclad SiO₂ layer 105 should be sufficient to accommodate the mode field of light propagating in the SiO₂ core 103 of the second optical waveguide 120. That is, the clad layers 102 and 105 may have a thickness such that the mode field of light propagating through the second optical waveguide 120 does not seep into the air layer directly above the substrate 101 and the overclad SiO₂ layer 105. Generally, it is sufficient that the thickness of the clad SiO₂ layers 102 and 105 is about several tens of μm.

In the direction perpendicular to the substrate, the center height of the Si core 104 of the first optical waveguide 110 and the center height of the SiO₂ core 103 of the second optical waveguide 120 can be matched by setting as follows.

That is, if it is enough if the thickness of the lower SiO₂ layers 103-1a and 103-2a is set to a difference between ½ of the overall height of the SiO₂ core 103 and ½ of the height of the Si core 104. At this time, it is possible to completely match the center heights of the both cores of the two optical waveguides, and solve incompleteness of adiabatic coupling in the SSC structure of the prior art and the problems of connectivity due to deterioration of butt coupling efficiency.

Unlimited Number of Modes, Core Size, MFD of Case of Single

Mode

In the optical waveguide component 100 of FIG. 1, neither the first optical waveguide 110 nor the second optical waveguide 120 has an upper limit on the core cross-sectional size, and it can also be a multi-mode optical waveguide that propagates a plurality of modes of light with respect to the wavelength of the optical signal to be used. Further, by reducing the core cross-sectional size, it is possible to obtain the single-mode optical waveguide that propagates only the lowest-order mode.

In the first optical waveguide 110, the Si layer is the core 104, the SiO₂ layers 103-1a and 103-1b are clads as shown in FIG. 1, or the air is as the clad as shown in (b) of FIG. 2, and the difference in the refractive index between the core and the clad is large. Therefore, the cross-sectional size of the core can be reduced to several hundred nm. On the other hand, the second optical waveguide 120 using the SiO₂ layer as the material of the core and difference in refractive index between the core and the clad is smaller than the first optical waveguide 110. Therefore, the core cross-sectional size of the second optical waveguide 120 is about several μm-10 μm square.

When both the first optical waveguide 110 and the second optical waveguide 120 are single-mode optical waveguides, the core cross-sectional size is about several hundred nm in the case of the first optical waveguide and several μm-10 μm in the case of the second optical waveguide 120. Therefore, the MFDs of the light propagating in the cores of the two optical waveguides are remarkably different, and the MFD of the second optical waveguide 120 becomes a larger value than the MFD of the first optical waveguide 110.

### Coupling Method

The method of connecting the cores of the optical waveguides in single mode is roughly divided into two types. One connection method is adiabatic coupling, in which both cores of the two optical waveguides are arranged so as to be in contact with each other in the propagation direction, and one of the optical waveguide cores makes the equivalent index of refraction of the mode propagating within the core gradually reduce by tapering optical waveguide into tapered shape. With such a configuration, the light energy of the mode that can no longer be confined is adiabatically transited to the other adjacent optical waveguide core. The other connection method is butt coupling, in which the end faces of the cores are abutted and arranged, and the coupling efficiency is defined by the overlap integral of the mode profiles existing in both cores of the two optical waveguides.

In the optical waveguide component 100 of the present disclosure, when both the first optical waveguide 110 and the second optical waveguide 120 are single-mode optical waveguides, one or both connection methods of adiabatic coupling and butt coupling are used in the SSC region 130 connecting the two types of optical waveguides.

The second optical waveguide 120 exhibits the larger MFD than the first optical waveguide 110. In order to connect the first optical waveguide 110 and the second optical waveguide 120 with low loss, it is desirable to match the MFD near the boundary between the two types of optical waveguides. In order to achieve MFD matching, the MFD of the first optical waveguide 110 is gradually expanded to match the MFD of the second optical waveguide 120. The structure that realizes this MFD enlargement function is not limited, but for example, there is a structure in which the Si core has a tapered shape 104-1 as in the SSC region 130 of FIG. 1. In order to gradually increase the MFD of the Si core 104, the equivalent refractive index of the mode in the Si core 104 may be gradually reduced. By making the Si core of the SSC region 130 the tapering tapered shape portion 104-1, the equivalent refractive index can be reduced as it approaches the second optical waveguide 120. In the region where the Si core 104-1 is sandwiched between the upper and lower SiO₂ core portions 103-1a and 103-1b, the tapered Si core allows to reduce the equivalent refractive index, and allows some or all of the light energy in the Si core to adiabatically transition to the SiO₂ core 103 of the second optical waveguide 120.

Portion of the light energy in the Si core 104 may propagate in the Si core 104 without adiabatic coupling with the SiO₂ core 103 and reach to the boundary between the first optical waveguide and the second optical waveguide. In such a case, the Si core 104 of the first optical waveguide 110 is butt coupling with the SiO₂ core 103 of the second optical waveguide 120 at the boundary. Part of the light energy that has not been adiabatically coupled in the Si core 104 can be efficiently coupled by manufacturing the optical waveguide component 100 so that the center heights of the Si core 104 and the SiO₂ core 103 match. By matching the center heights of the two cores, the butt coupling efficiency defined by the overlap integral of the mode field can be kept high and the light energy can be coupled with low loss between the two optical waveguides.

As described in detail above, according to the optical waveguide component 100 of the embodiment, optical waveguides of different materials can be monolithically integrated on a common single substrate, and integrate two types of optical waves having different mode field sizes, and can be provided configurations that connect the waveguide with low loss. In the embodiment of FIG. 1 described above, two optical waveguides are coupled to each other with low loss to form a continuous single optical waveguide, but a plurality of optical waveguides made of different materials are also coupled to each other with low loss.

### Second Embodiment: Pitch Conversion

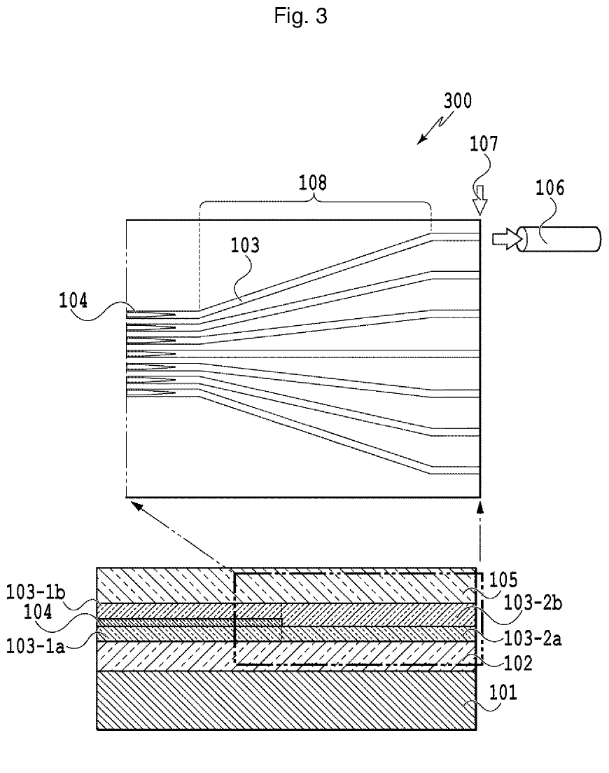

FIG. 3 is a diagram showing the configuration of the optical waveguide component of the second embodiment. In the optical waveguide component 300 of the second embodiment, the plurality of first optical waveguides and the same number of second optical waveguides are coupled with low loss. The structure between the first optical waveguide and the corresponding second optical waveguide among the plurality of first optical waveguides is the same as that of the optical waveguide component 100 of the first embodiment shown in FIG. 1, therefore, the description thereof will be omitted.

As described in the first embodiment, the Si core 104 of the first optical waveguide can confine light in a very small cross-section as compared with the second optical waveguide. Therefore, when it is desired to create many core patterns for a plurality of Si cores 104 in a narrow region, the pitch between cores can be narrowed to about several μm. On the other hand, the second optical waveguide having a core size larger than that of the first optical waveguide needs to have a core cross-sectional size of at least several μm-10 μm square even when the core width is made as narrow as possible. Therefore, the core-to-core pitch assumed when arranging the SiO₂ cores 103 of the plurality of second optical waveguides is several tens of μm to several hundreds of μm.

In the optical waveguide component 300 of FIG. 3, when the same number of corresponding second optical waveguides as the plurality of first optical waveguides are connected at high density, the plurality of Si cores 104 and the plurality of SiO₂ cores 103 are necessary to form at the same pitch between cores.

The inter-core pitch at that time is arbitrary, but in the case of high-density wiring, it is desirable to set it to, for example, several tens of μm in accordance with the minimum inter-core pitch of the second optical waveguide

On the other hand, for example, another end face 107 of the second optical waveguide on the substrate, away from the connection with the first optical waveguide, may have a core-to-core pitch different from that of the connection. When connecting to an optical fiber array, the core-to-core pitch of the SiO₂ core 103 near the end face 107 of the second optical waveguide is determined in accordance with 125 μm or 250 μm, which is a standard for the inter-core pitch of the optical fiber. In such a case, the distance between the waveguides is extended with respect to the SiO₂ core 103 of the second optical waveguide from the vicinity of the connection portion with the first optical waveguide to another end face 107 away from the connection portion. The region 108 that extends the spacing between waveguides is configured by patterning that includes straight lines, curves, or combinations of straight lines and curves. By the region 108 that extends the spacing between the waveguides, the second optical waveguide is, smoothly extended from the plurality of first optical waveguides to another end face 107 of the substrate of the second optical waveguide, and can be optically connected to the optical fiber array 106.

As described above, according to the present embodiment, even when the connection portions of a plurality of optical waveguides are arranged for two types of optical waveguides having significantly different MFDs, the configuration of the connection portions of the present disclosure is possible to provide the optical waveguide component to connect both waveguides low in loss.

### Third Embodiment: Manufacturing Method

FIG. 4 is a diagram illustrating a process of a manufacturing method of the optical waveguide component of the present disclosure. This embodiment is the method for manufacturing the optical waveguide component shown in the first embodiment and the second embodiment, and the structure of the optical waveguide component to be manufactured is the first embodiment and the second embodiment, since it is as described in the above, the description thereof will be omitted. (a) to (e) of FIG. 4 show the steps in order until the optical waveguide component 100 of FIG. 1 is manufactured.

Referring to (a) of FIG. 4, the SiO₂ layer 102 (first layer) is formed on the substrate 101 whose surface is smooth enough to form a SiO 2 layer on the substrate 101. Specific examples of the substrate 101 include a glass substrate and the like, and a Si substrate is particularly suitable. The method for forming the SiO₂ layer 102 is not limited as long as it can form a layer that is uniform and smooth enough to form another layer directly above the formed layer. As an example, there is a film formation method of a SiO₂ layer such as a flame deposition method. Immediately above the SiO₂ layer 102, a SiO₂ layer 203-a (second layer) having a higher refractive index than the SiO₂ layer 102 is formed. In forming the SiO₂ layer 203-a, the refractive index may be controlled by adding GeO₂, ZrO₂, HfO₂, P₂O₅, B₂O₃, or the like. After undergoing a step of flattening the SiO₂ layer 203-a by means such as CMP (Chemical Mechanical Polishing), a Si layer 204 (third layer) is formed directly above the SiO₂ layer 203-a and flattened.

Here, referring to FIG. 1 again, the above-mentioned SiO₂ layer 203-a is a layer for the 103-1a and 103-2a of the lower side within the SiO₂ region of the four core portions 103-1a, 103-1b, 103-2a, 103-2b that span the two optical waveguides of FIG. 1.

In forming the Si layer 204, a film may be formed by sputtering of amorphous silicon, or a desired Si film thickness may be obtained after another Si substrate is attached to the upper surface of the substrate 101 (on the SiO₂ layer 203-a). In the state (a), in a general SOI substrate, instead of forming a single SiO₂ layer, that is, a BOX (Buried Oxide) layer under the Si layer of the surface layer, two SiO₂ layers having different refractive indexes, that is, it can be said that the SiO₂ layer 102 and the SiO₂ layer 203-a are formed.

Next, referring to (b) of FIG. 4, the Si layer 204 is processed so as to be able to propagate light as the optical waveguide core, and the Si core 104 of the first optical waveguide is manufactured. Although not shown in (b) of FIG. 4, the optical circuit of Si photonics beyond the Si core 104 may be formed in combination with the formation of the Si core 104.

Further, referring to (c) of FIG. 4, the SiO₂ layer 203-b (fourth layer) is formed directly above the SiO₂ layer 203-a and the Si core 104. The SiO₂ layer 203-b has the refractive index similar to that of the SiO₂ layer 203-a. Referring again to FIG. 1, the above-mentioned SiO₂ layer 203-b is the layer for 103-1b and 103-2b of the upper sides, within the SiO₂ region of the four core portions 103-1a, 103-1b, 103-2a, and 103-2b across the two optical waveguides of FIG. 1.

Next, referring to (d) of FIG. 4, the SiO₂ layer 203-a and the SiO₂ layer 203-b is processed together, and obtains SiO₂ core 103 (core portions 103-2a and 103-2b) to be able to propagate light as the core of the second optical waveguide. At the same time, core portions 103-1a and 103-1aare also formed as “clads” of the first optical waveguide. At this stage, it is desirable that the width of the SiO₂ core 103 to be collectively processed is wider than the width of the Si core 104 that has already been processed. This is because the side wall of the Si core 104 that has already been machined is not affected when the SiO₂ core 103 is machined.

Finally, referring to FIG. 4 (e), the optical waveguide component 100 can be manufactured by forming the SiO₂ layer 105 (fifth layer) having a refractive index lower than that of the SiO₂ core 103.

One embodiment of the present invention is a method for manufacturing an optical waveguide component 100 including a first optical waveguide 110 and a second optical waveguide 120 having a different mode field diameter (MFD), a method for manufacturing an optical waveguide component comprising: a step of forming a first layer 102 to be a lower clad on a substrate 101; a step of forming a second layer 203-a for the lower core of the second optical waveguide by a material having a higher refractive index than the first layer; a step of forming a third layer 204 for a core 104 of the first optical waveguide by a material having an even higher refractive index than the second layer; a step of forming a core of the first optical waveguide by processing the third layer;

a step of forming a fourth layer 203-b for the upper core of the second optical waveguide by a material having a refractive index similar to a refractive index of the second layer; a step of forming a core of the second optical waveguide by processing collectively the second layer and the fourth layer; and a step of forming a fifth layer 103 for an upper clad by a material having a lower refractive index than the second layer and the fourth layer.

As described above, according to the present embodiment, it is possible to provide a simple method for manufacturing the optical waveguide component shown in the first embodiment and the second embodiment.

As described in detail above, according to the optical waveguide component of the first and second embodiments and the method for manufacturing the optical waveguide component of the third embodiment, two types of optical waveguides with cores with different refractive indexes can be connected with low loss, with the simple process that is equivalent to the optical waveguide component manufacturing process by the general laminating process. In particular, by making the structure so that the core center heights of the two optical waveguides match each other, it is possible to connect to a lower loss. According to the present invention, it is possible to provide the optical waveguide component capable of easily connecting optical waveguides having significantly different MFDs.

### INDUSTRIAL APPLICABILITY

The present invention can be used for devices that use optical communication.

1. An optical waveguide component, in which an optical waveguide having a different mode field diameter (MFD) is formed on a substrate, an optical waveguide component comprising:
a first optical waveguide including
a first core made of a first material, and
a clad made of a second material formed above and below the first core;
a second core made of the second material formed by extending from the clad along the first core;
a lower clad made of a third material configured between the substrate and the second core, and
a second optical waveguide
including an upper clad configured on the second core, wherein
the region of the first core is contained in the region of the second core in a cross-section perpendicular to the lengthwise direction of the optical waveguide, and
the first material has the highest refractive index, and the third material has the smallest refractive index.

2. The optical waveguide component according to claim 1, the thickness of the clad formed beneath the first core is set to a difference between ½ the height of the second core and ½ the height of the first core, wherein the center height of the first core and the center height of the second core are equal.

3. The optical waveguide component according to claim 1, wherein the first optical waveguide and the second optical waveguide are single-mode waveguides with respect to the wavelength of the optical signal to be guided.

4. The optical waveguide component according to claim 1, wherein the tip portion of the first core has a structure for changing the MFD of an optical signal propagating through the first optical waveguide.

5. The optical waveguide component according to claim 4,
The structure that changes the MFD is
a taper that is changed the width in the direction parallel to the substrate or the height in the direction perpendicular to the substrate at the tip toward the second optical waveguide,
a segment that the first core is formed intermittently, or a structure that the taper and the segment are combined.

6. The optical waveguide component according to claim 1, comprising: a plurality of the first optical waveguides; and
the plurality of the second optical waveguides corresponding to each of the plurality of the first optical waveguides and arranged at an interval different from the interval of the plurality of first optical waveguides through an area for expanding the interval between the waveguides.

7. The optical waveguide component according to claim 1, the first material, the second material, and the third material are made of any one of Si, SiN, SiON, SiOₓ, and polymer as a base material, wherein
the difference in the refractive index is caused by the difference in the base material or,
the difference in the refractive index is caused by the difference in the amount of impurity added to the base material.

8. A method for manufacturing an optical waveguide component including a first optical waveguide and a second optical waveguide having a different mode field diameter (MFD), a method for manufacturing an optical waveguide component comprising:
a step of forming a first layer to be a lower clad on a substrate;
a step of forming a second layer for the lower core of the second optical waveguide by a material having a higher refractive index than the first layer;
a step of forming a third layer for a core of the first optical waveguide by a material having an even higher refractive index than the second layer;
a step of forming a core of the first optical waveguide by processing the third layer;
a step of forming a fourth layer for the upper core of the second optical waveguide by a material having a refractive index similar to a refractive index of the second layer;
a step of forming a core of the second optical waveguide by processing collectively the second layer and the fourth layer; and
a step of forming a fifth layer for an upper clad by a material having a lower refractive index than the second layer and the fourth layer.

9. The optical waveguide component according to claim 2, wherein the first optical waveguide and the second optical waveguide are single-mode waveguides with respect to the wavelength of the optical signal to be guided.

10. The optical waveguide component according to claim 2, wherein the tip portion of the first core has a structure for changing the MFD of an optical signal propagating through the first optical waveguide.

11. The optical waveguide component according to claim 3, wherein the tip portion of the first core has a structure for changing the MFD of an optical signal propagating through the first optical waveguide.

12. The optical waveguide component according to claim 2, comprising: a plurality of the first optical waveguides; and
the plurality of the second optical waveguides corresponding to each of the plurality of the first optical waveguides and arranged at an interval different from the interval of the plurality of first optical waveguides through an area for expanding the interval between the waveguides.

13. The optical waveguide component according to claim 3, comprising: a plurality of the first optical waveguides; and
the plurality of the second optical waveguides corresponding to each of the plurality of the first optical waveguides and arranged at an interval different from the interval of the plurality of first optical waveguides through an area for expanding the interval between the waveguides.

14. The optical waveguide component according to claim 4, comprising: a plurality of the first optical waveguides; and
the plurality of the second optical waveguides corresponding to each of the plurality of the first optical waveguides and arranged at an interval different from the interval of the plurality of first optical waveguides through an area for expanding the interval between the waveguides.

15. The optical waveguide component according to claim 5, comprising: a plurality of the first optical waveguides; and
the plurality of the second optical waveguides corresponding to each of the plurality of the first optical waveguides and arranged at an interval different from the interval of the plurality of first optical waveguides through an area for expanding the interval between the waveguides.

16. The optical waveguide component according to claim 2, the first material, the second material, and the third material are made of any one of Si, SiN, SiON, SiOₓ, and polymer as a base material, wherein
the difference in the refractive index is caused by the difference in the base material or,
the difference in the refractive index is caused by the difference in the amount of impurity added to the base material.

17. The optical waveguide component according to claim 3, the first material, the second material, and the third material are made of any one of Si, SiN, SiON, SiOₓ, and polymer as a base material, wherein
the difference in the refractive index is caused by the difference in the base material or,
the difference in the refractive index is caused by the difference in the amount of impurity added to the base material.

18. The optical waveguide component according to claim 4, the first material, the second material, and the third material are made of any one of Si, SiN, SiON, SiOₓ, and polymer as a base material, wherein
the difference in the refractive index is caused by the difference in the base material or,
the difference in the refractive index is caused by the difference in the amount of impurity added to the base material.

19. The optical waveguide component according to claim 5, the first material, the second material, and the third material are made of any one of Si, SiN, SiON, SiOₓ, and polymer as a base material, wherein
the difference in the refractive index is caused by the difference in the base material or,
the difference in the refractive index is caused by the difference in the amount of impurity added to the base material.

20. The optical waveguide component according to claim 6, the first material, the second material, and the third material are made of any one of Si, SiN, SiON, SiOₓ, and polymer as a base material, wherein
the difference in the refractive index is caused by the difference in the base material or,
the difference in the refractive index is caused by the difference in the amount of impurity added to the base material.
